(19) United States
(12) Patent Application Publication
(10) Pub. No.: US 2011/0113052 A1
(43) Pub. Date: May 12, 2011

(54) QUERY RESULT ITERATION FOR MULTIPLE QUERIES

(76) Inventor: JOHN HÖRNKVIST, Cupertino, CA (US)

(21) Appl. No.: 13/007,543

(22) Filed: Jan. 14, 2011

Related U.S. Application Data
(63) Continuation-in-part of application No. 12/781,767, filed on May 17, 2010.
Application No. 12/781,767 is a continuation of application No. 11/760,707, filed on Jun. 8, 2007, now Pat. No. 7,720,860.

(51) Int. Cl. G06F 17/30

(52) U.S. Cl. 707/759; 707/E17.07

(57) ABSTRACT

Systems and methods for processing an inverted index are described. Multiple queries against the same inverted index are merged into merged query of unique nodes. The unique nodes are used to create a unified document set from which query result iteration is performed to eliminate redundancies and/or inefficiencies in processing the multiple queries separately. The merged query result is separated into the results for each of the multiple queries and returned to the respective originators of the queries. The unified document set can be limited to postings lists found in a single pulse of the inverted index to improve performance. Index updates can be applied to the merged query result to provide efficient and up to date query results.

This application is a continuation-in-part of co-pending U.S. patent application Ser. No. 12/781,767, filed on May 17, 2010, which is a continuation of U.S. patent application Ser. No. 11/760,707, filed on Jun. 8, 2007, which issued as U.S. Pat. No. 7,720,860 on May 18, 2010.

### BACKGROUND

Modern data processing systems, such as general purpose computer systems, allow the users of such systems to create a variety of different types of data files. For example, a typical user of a data processing system may create text files with a word processing program such as Microsoft Word or may create an image file with an image processing program such as Adobe's PhotoShop. Numerous other types of files are capable of being created or modified, edited, and otherwise used by one or more users for a typical data processing system. The large number of the different types of files that can be created or modified can present a challenge to a typical user who is seeking to find a particular file which has been created.

Modern data processing systems often include a file management system which allows a user to place files in various directories or subdirectories (e.g. folders) and allows a user to give the file a name. Further, these file management systems often allow a user to find a file by searching not only the content of a file, but also by searching for the file's name, or the date of creation, or the date of modification, or the type of file. An example of such a file management system is the Finder program which operates on Macintosh computers from Apple Inc. of Cupertino, Calif. Another example of a file management system program is the Windows Explorer program which operates on the Windows operating system from Microsoft Corporation of Redmond, Wash. Both the Finder program and the Windows Explorer program include a find command which allows a user to search for files by various criteria including a file name or a date of creation or a date of modification or the type of file. This search capability searches through information which is the same for each file, regardless of the type of file. Thus, for example, the searchable data for a Microsoft Word file is the same as the searchable data for an Adobe PhotoShop file, and this data typically includes the file name, the type of file, the date of creation, the date of last modification, the size of the file and certain other parameters which may be maintained for the file by the file management system.

Certain presently existing application programs allow a user to maintain data about a particular file. This data about a particular file may be considered metadata because it is data about other data. This metadata for a particular file may include information about the author of a file, a summary of the document, and various other types of information. Some file management systems, such as the Finder program, allow users to find a file by searching through the metadata.

In a typical system, the various content, file, and metadata are indexed for later retrieval using a program such as the Finder program, in what is commonly referred to as an inverted index. For example, an inverted index might contain a list of references to documents in which a particular word appears. Given the large numbers of words and documents in which the words may appear, an inverted index can be extremely large. The size of an index presents many challenges in processing and storing the index, such as updating the index or using the index to perform a search.

### SUMMARY OF THE DETAILED DESCRIPTION

Methods and systems for processing an inverted index in a data processing system are described herein.

According to one aspect of the invention, a method for querying an index is described in which the query is run against one pulse in the index in the absence of any marking to indicate where the pulse begins and ends. A pulse is formed when a postings list comprising a series of linked lists is flushed to disk. The method includes determining when the end of pulse has been reached based on certain characteristics of the linked list nodes and the pulses in which they are contained.

According to another aspect of the invention, a method for querying an index is described in which multiple separate queries against the index are merged prior to querying the index. The merged query is used to create a unified document set from the document sets for the multiple queries represented in the merged query. The documents sets are obtained from postings lists found in the index that correspond to each of the unique query nodes in the merged query. The unified document set is iterated to produce a merged query result, from which a separate query result is returned to each of the multiple separate queries.

### BRIEF DESCRIPTION OF THE DRAWINGS

The present invention is illustrated by way of example and not limitation in the figures of the accompanying drawings in which like references indicate similar elements.

FIG. 1 is a block diagram overview of an architecture for processing an inverted index according to one exemplary embodiment of the invention.

FIG. 2 is a block diagram illustrating one aspect of querying an index according to one exemplary embodiment of the invention.

FIG. 3 is a block diagram illustrating another aspect of querying an index according to one exemplary embodiment of the invention.

FIG. 4 is a flow diagram illustrating certain aspects of performing a method of processing updates to an index according to one exemplary embodiment of the invention.

FIG. 5 is a block diagram overview of an exemplary embodiment of a data processing system, which may be a general purpose computer system and which may operate in any of the various methods described herein.

FIG. 6 is a block diagram illustrating another aspect of querying an index according to one exemplary embodiment of the invention.

FIG. 7 is a flow diagram illustrating certain aspects of performing a method of querying an index according to one exemplary embodiment of the invention.

FIGS. 8A-8B are timeline diagrams illustrating two typical scenarios for performing a method of querying an index according to one exemplary embodiment of the invention.

### DETAILED DESCRIPTION

The embodiments of the present invention will be described with reference to numerous details set forth below, and the accompanying drawings will illustrate the described embodiments. As such, the following description and drawings are illustrative of embodiments of the present invention and are not to be construed as limiting the invention. Numerous specific details are described to provide a thorough understanding of the present invention. However, in certain instances, well known or conventional details are not described in order to not unnecessarily obscure the present invention in detail.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Computer, Inc. 2011.

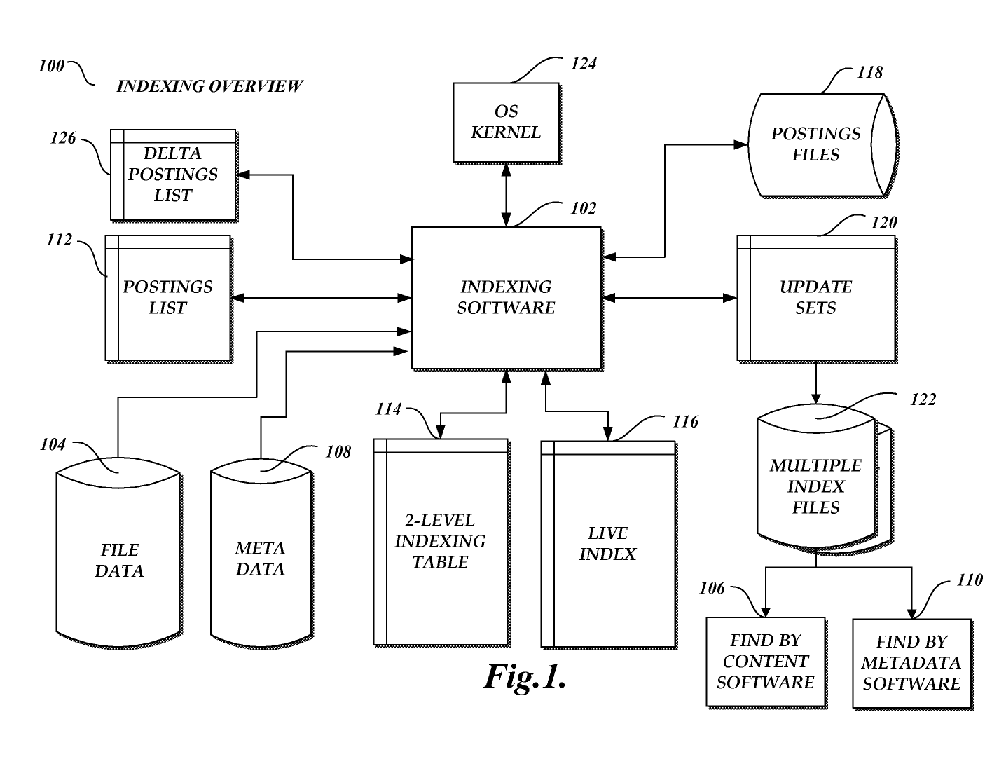

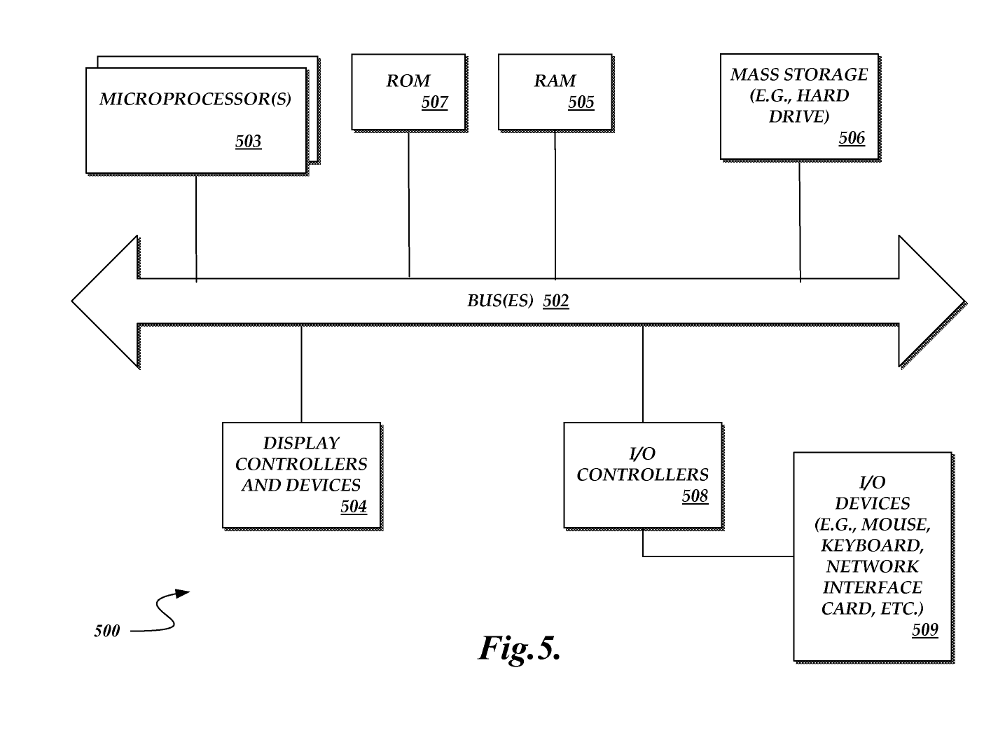

Various different software architectures may be used to implement the functions and operations described herein, such as to perform the method shown in FIG. 5. The following discussion provides one example of such an architecture, but it will be understood that alternative architectures may also be employed to achieve the same or similar results. The software architecture 100 shown in FIG. 1 is an example which is based upon the Macintosh operating system. The architecture 100 includes indexing software 102 and an operating system (OS) kernel 124 which is operatively coupled to the indexing software 102, as well as other software programs, such as find by content software 106 and find by metadata software 110 (which may be the Finder program referenced earlier), and other applications not shown.

In one exemplary embodiment, the find by content software 106 and/or the find by metadata software 110 are used to find a term present in the file data 104 or meta data 108. For example, the software 106/110 may be used to find text and other information from word processing or text processing files created by word processing programs such as Microsoft Word, etc.

The find by content software 106 and find by metadata software 110 are operatively coupled to databases which include one or more indexes 122. The indexes 122 represent at least a subset of the data files in a storage device, including file data 104 and meta data 108, and may include all of the data files in a particular storage device (or several storage devices), such as the main hard drive of a computer system. The one or more indexes 122 comprise an indexed representation of the content and/or metadata of each item stored on the data files 104/108, such as a text document, music, video, or other type of file. The find by content software 106 searches for a term in that content by searching through the one or more index files 122 to see if the particular term, e.g., a particular word, is present in items stored on data files 104 which have been indexed. The find by content software functionality is available through find by metadata software 110 which provides the advantage to the user that the user can search the indexes 122 for the content 104 within an item stored on the data files 104 as well as any metadata 108 that may have been generated for the item.

In one embodiment of the present invention, indexing software 102 is used to create and maintain the one or more indexes 122 that are operatively coupled to the find by content and metadata software applications 106/110. Among other functions, the indexing software 102 receives information obtained by scanning the file data 104 and metadata 108, and uses that information to generate a postings list 112 that identifies an item containing a particular term, or having metadata containing a particular term. As such, the postings list 112 is a type of inverted index that maps a term, such as a search term, to the items identified in the list. In a typical embodiment, the information obtained during the scan includes a unique identifier that uniquely identifies the item containing the particular term, or having metadata containing the term. For example, items such as a word processing or text processing file have unique identifiers, referred to as ITEMIDs. The ITEMIDs are used when generating the postings list 112 to identify those items that contain a particular term, such as the word “Apple.” ITEMIDs identifying other types of files, such as image files or music files, may also be posted to the postings list 112, in which case the ITEMID typically identifies items having metadata containing a particular term.

In one embodiment, the indexing software 102 accumulates postings lists 112 for one or more terms into one or more update sets 120 and, from time to time, flushes the updates sets 120 into one or more index files 122. The postings lists 112 for one or more items may also be stored in a postings file 118. The indexing software 102 may employ one or more indexing tables 114 that comprise one or more term tables, including a two-level table that separates the more frequently occurring terms from the less frequently occurring terms. The tables 114 may also include a postings table that comprises one or more postings lists for the terms that are being indexed. In one embodiment, the indexing software may maintain a live index 116 to contain the most current index. In some cases, updates to an index may be generated in a delta postings list 126 that is a specially marked postings list that may be dynamically applied to an index 122, postings files 118, updates sets 120, or other forms of an index in order to insure that the most current information is returned whenever those indexes are accessed.

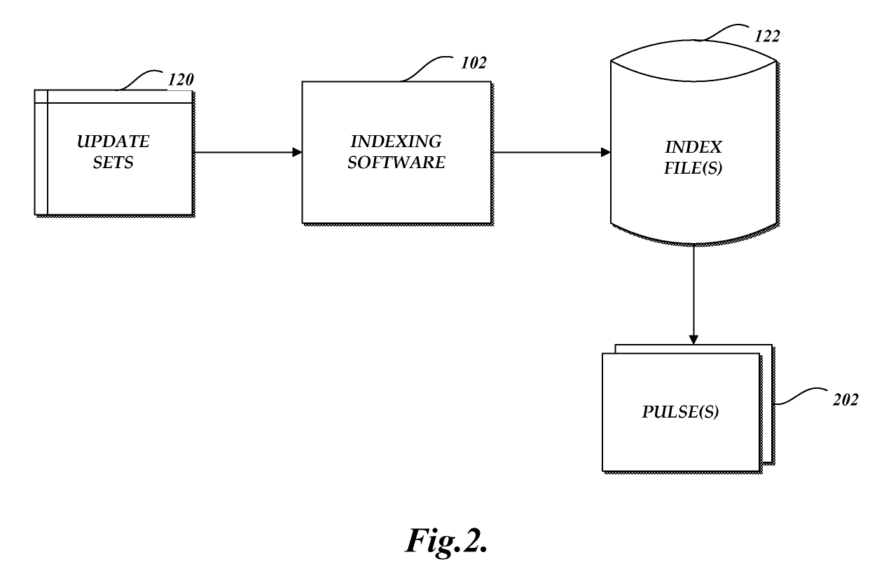

FIG. 2 is a block diagram illustrating one aspect of querying an index according to one exemplary embodiment of the invention. A postings list of a single term is stored as a linked list of one or more nodes, where each node represents an item ID of an item containing the term. As illustrated in FIG. 2, indexing software 102 flushes an update set 120 comprising postings lists for several terms to an index file 122 on disk. As a result, a pulse 202 is formed on the disk in which an item ID occurring in the pulse cannot occur in any other pulse on the disk.

When running a query against an index 122 containing pulses 202, such as that illustrated in FIG. 2, it would be helpful to restrict the query to just one pulse, so that the query would run more efficiently and so that any updates, typically from a live index or from a delta postings list, could be applied to the query result obtained from just one pulse.

Unfortunately, there is no marking or indication in the index to indicate where one pulse ends and another begins. Embodiments of the present invention overcome this problem by taking into consideration the characteristics of a pulse and the nodes that comprise them.

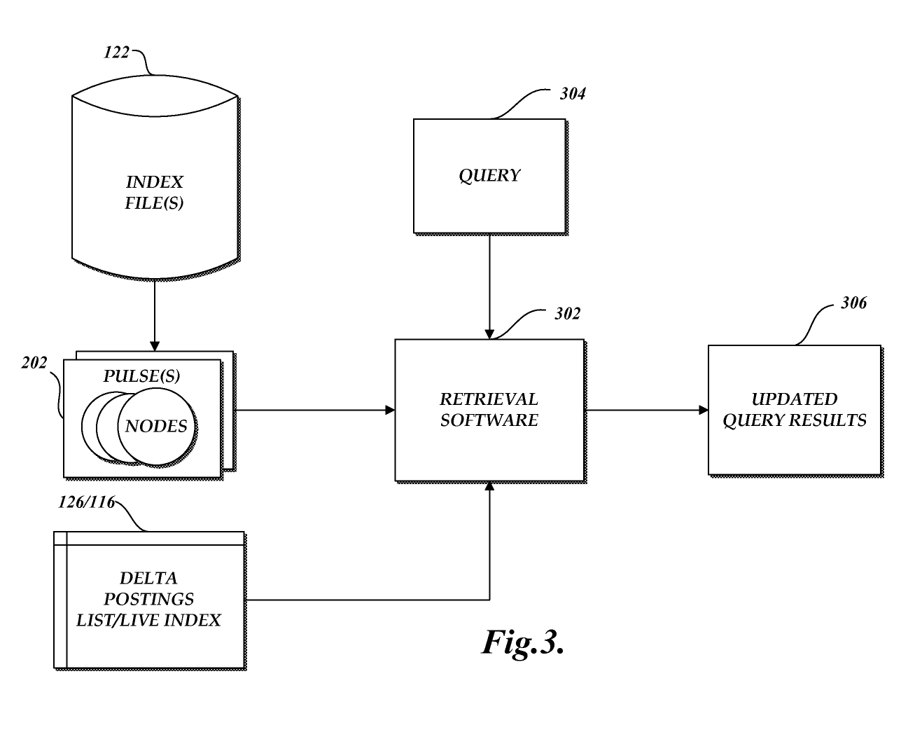

FIG. 3 is a block diagram illustrating one aspect of querying an index according to one exemplary embodiment of the invention. When a pulse is formed, it is comprised of linked list nodes, and each linked list node can only correspond to one pulse. In addition, when the postings list was created (prior to being flushed to disk), each node in the linked list was updated to point only to older nodes, i.e., nodes representing items already in the postings list. Because each node only points to older nodes, which are logically ahead in the index, there is said to be a “closest next node.” The closed next node is a node that is pointed to from a node in the current pulse.

When running the query 304 against the index 122, retrieval software 302 generates a sorted queue of nodes that contain the desired term. During processing the sorted queue of nodes, the end of the pulse can be detected when the next node in the queue is equal to the closest next node, i.e. is a node that is pointed to from a node in the current pulse.

Generally, it cannot be determined whether more than one pulse 202 has already been processed. In the typical case, it is more likely that a group of pulses has been processed, and likely that at least one partial pulse has been processed. As a result, before the processing of a pulse is finalized, it is necessary to either detect one more pulse, or have no more nodes to process.

To finalize the processing of a pulse, retrieval software 302 keeps track of the range of item IDs occurring in a single pulse, and processes item IDs up to the highest item ID in the current pulse. Any updates, such as updates from a live index or a delta postings list 126 may be applied to the query result 306 when the end of a pulse has been reached, or when a matching item ID is reached.

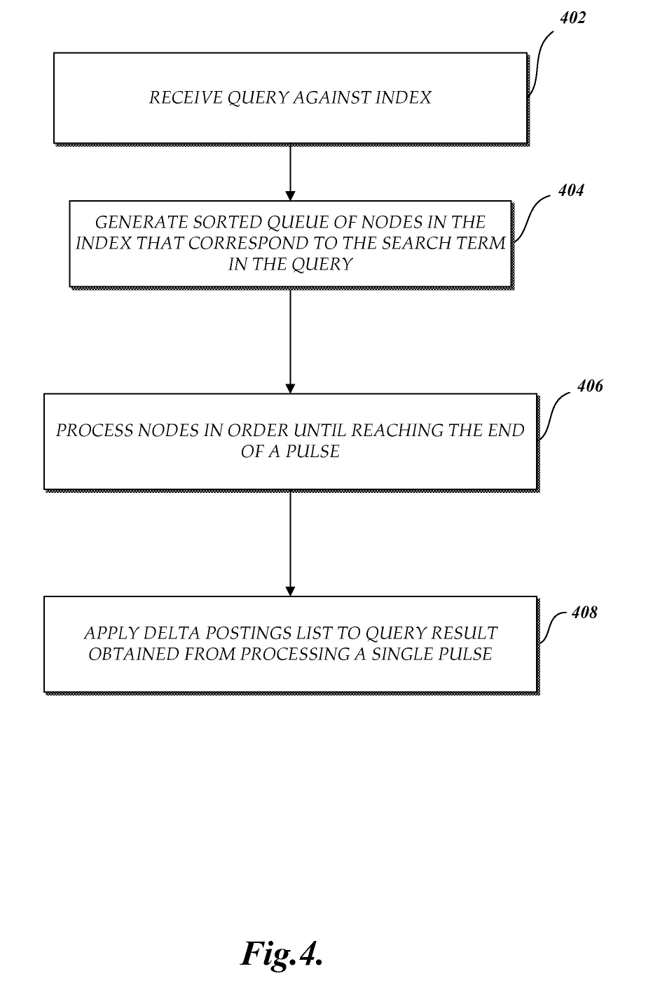

FIG. 4 is a flow diagram illustrating certain aspects of performing a method of querying an index according to one exemplary embodiment of the invention. In FIG. 4, the method to be performed begins at block 402, in which retrieval software receives a query to run against an index containing pulses. At block 404, the retrieval software generates a sorted queue of nodes in the index that correspond to the search term provided in the query. At processing block 406, the nodes are processed in order until reaching the end of the pulse or until no more nodes are left to process. The end of the pulse is detected when the next node in the queue is equal to the closest next node. To finalize the processing of the pulse, the retrieval software keeps track of the range of item IDs occurring in a single pulse, and processes item IDs up to the highest item ID in the current pulse.

Once processing for the current pulse is complete, at block 408, the retrieval software concludes processing by applying available delta postings lists, or live indexes, or other form of updates to the index, to the query result that was obtained in blocks 402-406.

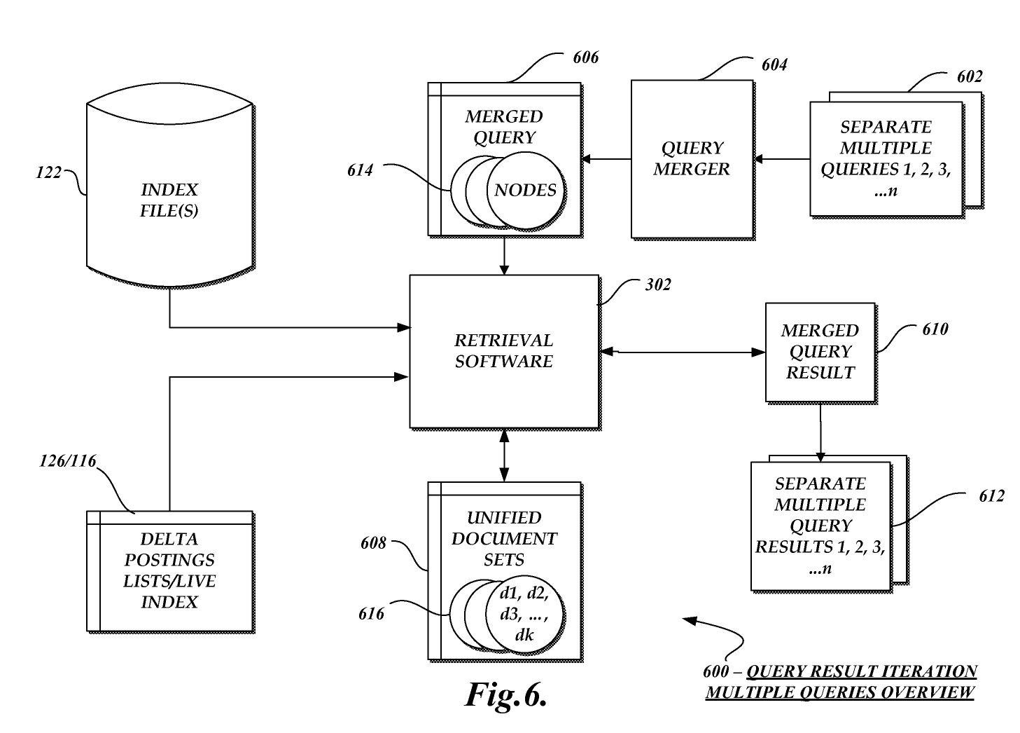

FIG. 6 is a block diagram illustrating one aspect of querying an index according to one exemplary embodiment of the invention. When multiple queries q1, q2, q3, . . . qn 602 are received for processing against the same index 122, the multiple queries 602 may first be processed by a query execution engine executing a query merger process 604 to merge the queries into a single merged query 606 containing unique nodes 614 that were extracted from the multiple queries 602. The single merged query 606 can then be processed against the index 122 by a query execution engine executing the retrieval software 302 to produce a merged query result 610. The merged query result 610 can then be parsed into separate multiple query results 1, 2, 3, . . . n, 612 for return to their corresponding query originators. In this manner, any redundancies and/or inefficiencies that would otherwise have been encountered in processing the multiple queries against the index separately can be minimized.

In a typical embodiment, the retrieval software 302 processes a merged query 606 by finding in the index 122 the postings lists corresponding to each of the unique nodes 614 present in the merged query 606, each unique node 614 representing a search term that was present in one or more of the separate multiple queries 602 from which the merged query 606 was formed. The retrieval software 302 then creates a single unified document set 608 from all of the documents sets d1, d2, d3, . . . dk 616 that comprise the postings lists found in the index 122. The single unified document set 608 is then iterated to generate the merged query result 610, which, as noted above, is then parsed into separate multiple query results 1, 2, 3, . . . n, 612 for return to their corresponding separate query originators, e.g., the applications and/or clients that initiated the original queries. In a typical embodiment, the parsing of the separate query results from the merged query result is based on the presence of the search term in the items representing the result, and mapping the search term back to the originating individual query (or queries) from among the multiple queries 602.

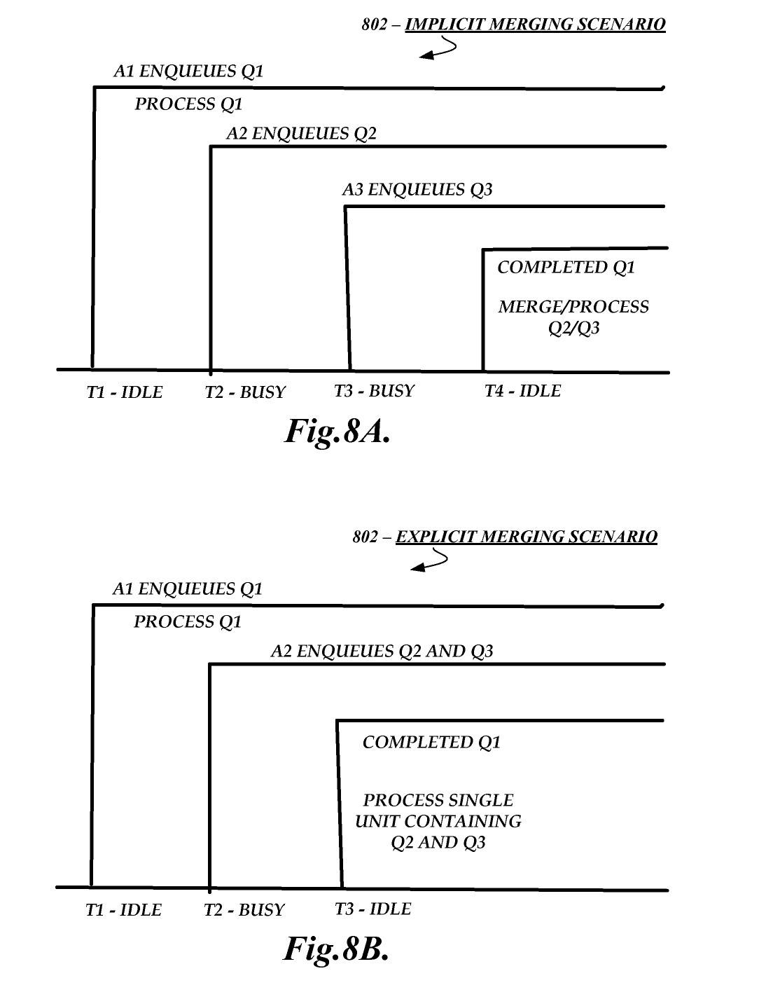

As will be explained in further detail in FIGS. 8A-8B below, in one embodiment multiple queries may be processed implicitly or explicitly. Implicit handling of multiple queries typically occurs on the server side of query processing, with a server query execution engine merging any queries from one or more applications that are awaiting processing in the queue. In this manner, the multiple query result iteration processing only occurs when clients attempt to start querying the index 122 while the query execution engine is already busy processing other queries.

In contrast, explicit handling of multiple queries typically occurs on the client side of query processing, with a client application explicitly merging two or more queries into a single unit prior to querying the index 122. In some embodiments, the multiple query processing may include both explicit and implicit processing. For example, in one embodiment, some applications may explicitly merge queries before sending them to the query execution engine, which in turn merges them with other applications' queries when the query execution engine is ready to process.

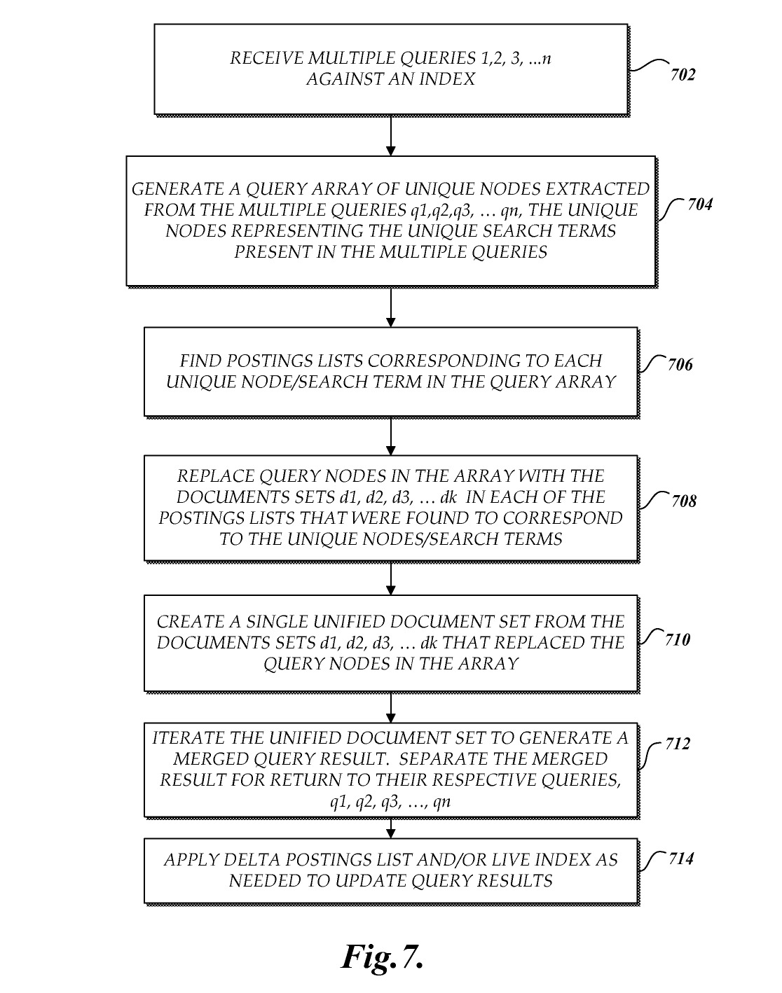

FIG. 7 is a flow diagram illustrating certain aspects of performing a method of querying an index according to one exemplary embodiment of the invention. In FIG. 7, the method to be performed begins at block 702, in which a processor for a query execution engine which receives multiple queries to run against the same index. At block 704, the processor executes a query merger process in which a query array of unique nodes are extracted from the multiple queries q1, q2, q3, . . . qn, where the unique nodes represent each of the unique search terms present in the multiple queries. For example, if the multiple queries from three users may include, respectively, six search terms “joe” and “email,” “email” and “donna,” and “donna” and “word.” Since some of the terms are the same, the query merger process eliminates the redundancies across the multiple separate queries, and generates a single query array with four search terms “joe,” “email,” “donna,” and “word.” In this manner the subsequent execution on the processor of the search retrieval process need only access the index once for each unique search term instead of twice for the redundant search terms.

At processing block 706, the search retrieval process finds in an inverted index postings lists corresponding to each of the unique nodes, i.e. search terms, in the unique query array. In one embodiment, the search retrieval process finds the postings lists in an inverted index containing pulses, in which case the search retrieval process may improve the search performance by finding the end of the pulse as described with reference to FIGS. 2-4 and restricting the search to the documents present in the pulse. Continuing at processing block 708, the search retrieval process replaces the query nodes in the array with the document sets d1, d2, d3, . . . dk present in each of the postings lists that were found to match the unique nodes/search terms. At processing block 710, the search retrieval process generates a single unified document set from the replacement document sets d1, d2, d3, . . . dk.

In one embodiment, the extraction of the unique query nodes, also referred to as unique factors, is performed by parsing each query string into a query tree, which is optimized for index processing. In a generalized example, the factors are extracted, in some canonical order, from each query tree, and into a single array. Using a depth first search as the canonical order, for example, q1=(a AND b) OR (c AND d) OR (a AND d) and q2=b OR e becomes {a,b,c,d,a,d,b,e}. The array is processed, in order, adding each unique query node to a dictionary and the single array. The dictionary key is the query node, and the value is the slot in the single array where the node is found. Therefore, the dictionary contains {a=1, b=2, c=3, d=4, e=5}.

In one embodiment, instead of using a dictionary, each unique factor or query node is assigned a number and then put into a factor array. Using depth first search as the order, and with reference to the generalized example introduced above, q1=(a AND b) OR (c AND d) OR (a AND d) and q2=b OR e becomes q1=(a,1 AND b,2) OR (c,3 AND d,4) OR (a,1 AND d,4) q2=(b,2 AND e,5) with the factor array={a,b,c,d,e}

Continuing with the generalized example, in one embodiment the single array of unique nodes or, alternatively, the factor array, is passed to the search retrieval process, which finds in the inverted index the postings lists corresponding to each query term. As noted above, if the inverted index contains pulses, the search retrieval process may improve performance by restricting the search to a single pulse formed in the inverted index as described with reference to FIGS. 2-4. Upon finding the postings lists corresponding to each query term, the process replaces the query nodes in the array with the document sets contained in the postings lists. The document sets are, in turn, used to create a query result iterator. The query tree is processed once again, and the document sets are associated with each unique node using the dictionary. Thus, for example, if the document sets are d1, d2, d3, d4, d5, then q1=(d1 AND d2) OR (d3 AND d4) OR (d1 AND d4), q2=(d2 OR d5). The unified document set is qu=((d1 AND d2) OR (d3 AND d4) OR (d1 AND d4)) OR (d2 OR d5)). In one embodiment, as an additional optimization, because d2 includes all results in (d1 AND d2) the unified document set is further optimized, and qu=(d3 AND d4) OR (d1 AND d4)) OR (d2 OR d5)).

Upon generating the unified document set, at processing block 712, the search retrieval process can iterate the unified document set to generate a merged query result. Then, the merged query result may be separated into the respective results for each of the original multiple queries based on the presence of the search term in the items, i.e., the documents, in the merged query result. For example, the identity of the queries that each result belongs to is determined by checking for the presence of the result items identifier in each query's document set, e.g. q1 or q2. The separated results may then be returned to each of the respective queries from which they originated.

Once processing of the merged query results is completed, at processing block 714, the retrieval process concludes processing by applying available delta postings lists, or live indexes, or other form of updates to the index, to the query results that were obtained in blocks 702-712.

As noted above, multiple queries may be processed implicitly or explicitly. FIGS. 8A-8B illustrate typical scenarios in which multiple queries may be handled in one embodiment of the invention. As shown in FIG. 8A, an exemplary implicit merging scenario 802 is encountered when at Time 1 (T1), Application 1 (A1) enqueues Query 1 (Q1). Since the query execution engine is idle at T1, it reacts by starting to process Q1. While the engine is busy processing Q1, A2 enqueues Q2 at T2, and A3 enqueues Q3 at T3. At T4, The query execution engine has finished with the work unit of Q1, and pulls the next queries from the query queue. Q2 and Q3 are ready to start, and are merged into a single work unit. In this scenario, the parallel processing of the queues through merging is implicitly exploited when clients attempt to start queries against an index while the query execution engine/server is busy.

As shown in FIG. 8A, an exemplary explicit merging scenario 804 is encountered when at Time 1 (T1), Application 1 (A1) enqueues Query 1 (Q1). Since the query execution engine is idle at T1, it reacts by starting to process Q1. While the engine is busy processing Q1, A2 enqueues both Q2 and Q3 at T2 as a single work unit. At T3, the query execution engine has finished with the work unit of Q1, and pulls the next queries from the query queue. Q2 and Q3 are already available for processing as a single work unit. In this scenario, the parallel processing of the queues through merging is explicitly exploited by clients by sending multiple queries together as a single unit of processing. As noted above, in some embodiments, the multiple query processing may provide functionality to support both explicit and implicit processing.

FIG. 5 illustrates an example of a typical computer system which may be used with the present invention. Note that while FIG. 5 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention. The computer system of FIG. 5 may, for example, be a Macintosh computer from Apple Inc.

As shown in FIG. 5, the computer system 501, which is a form of a data processing system, includes a bus 502 which is coupled to a microprocessor(s) 503 and a ROM (Read Only Memory) 507 and volatile RAM 505 and a non-volatile memory 506. The microprocessor 503 may be a G3 or G4 microprocessor from Motorola, Inc. or one or more G5 microprocessors from IBM. The bus 502 interconnects these various components together and also interconnects these components 503, 507, 505, and 506 to a display controller and display device 504 and to peripheral devices such as input/output (I/O) devices which may be mice, keyboards, modems, network interfaces, printers and other devices which are well known in the art. Typically, the input/output devices 509 are coupled to the system through input/output controllers 508. The volatile RAM (Random Access Memory) 505 is typically implemented as dynamic RAM (DRAM) which requires power continually in order to refresh or maintain the data in the memory. The mass storage 506 is typically a magnetic hard drive or a magnetic optical drive or an optical drive or a DVD RAM or other types of memory systems which maintain data (e.g. large amounts of data) even after power is removed from the system. Typically, the mass storage 506 will also be a random access memory although this is not required. While FIG. 5 shows that the mass storage 506 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 502 may include one or more buses connected to each other through various bridges, controllers and/or adapters as is well known in the art. In one embodiment the I/O controller 508 includes a USB (Universal Serial Bus) adapter for controlling USB peripherals and an IEEE 1394 controller for IEEE 1394 compliant peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 507, RAM 505, mass storage 506 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 503.

What is claimed is:

1. A machine-implemented method of processing multiple queries against an inverted index, the method comprising:
receiving multiple queries against an inverted index, the inverted index having stored thereon postings lists for terms, a postings list being a linked list of one or more nodes, each of the one or more nodes representing one or more items containing a term;
merging the multiple queries to a single merged query, the single merged query containing unique search terms extracted from the multiple queries;
generating a unified document set of document sets present in postings lists found in the inverted index to have items containing terms that match the unique search terms extracted from the multiple queries;
iterating the unified document set to generate a merged query result; and
returning a query result responsive to each of the multiple queries, the query result being identified in a portion of the merged query result based on the respective unique search terms extracted from the multiple queries.

2. A method as in claim 1, wherein the single merged query is formed as an array of unique nodes representing the unique search terms extracted from the multiple queries.

3. A method as in claim 2, wherein merging the multiple queries to the single merged query further comprises:
parsing each of the multiple queries into query trees;
optimizing the query trees for index searching;
extracting the unique search terms from the query trees in an order; and
placing the unique search terms into the array of unique nodes.

4. A method as in claim 1, further comprising updating the merged query result, wherein updating comprises:
determining that a delta postings list contains changes to items in the merged query result; and
updating the merged query result in accordance with the delta postings list, including removing from the merged query result identifications of those items no longer containing the matching search term and adding to the merged query result identifications of those items newly containing the matching search term.

5. A method as in claim 1, further comprising updating the merged query result, wherein updating comprises:
determining whether a live index contains postings lists for the term that matches the search term corresponding to the merged query;
processing the merged query against the live index; and
updating the merged query result in accordance with the live index merged query results.

6. A method as in claim 1, wherein the inverted index is formed in pulses comprising a group of items not occurring in any other pulse in the inverted index, and further wherein generating the unified document set is limited to document sets present in postings lists found in a single pulse formed in the inverted index.

7. A machine-readable storage medium storing program instructions that, when executed, cause a data processing system to perform a method of processing multiple queries against an inverted index, the method comprising:
receiving multiple queries against an inverted index, the inverted index having stored thereon postings lists for terms, a postings list being a linked list of one or more nodes, each of the one or more nodes representing one or more items containing a term;
merging the multiple queries to a single merged query, the single merged query containing unique search terms extracted from the multiple queries;
generating a unified document set of document sets present in postings lists having items containing terms that match the unique search terms extracted from the multiple queries;
iterating the unified document set to generate a merged query result; and
returning a query result responsive to each of the multiple queries, the query result being identified in a portion of the merged query result based on the respective unique search terms extracted from the multiple queries.

8. A medium as in claim 7, wherein the single merged query is formed as an array of unique nodes representing the unique search terms extracted from the multiple queries.

9. A medium as in claim 8, wherein merging the multiple queries to the single merged query further comprises:
parsing each of the multiple queries into query trees;
optimizing the query trees for index searching;
extracting the unique search terms from the query trees in an order; and
placing the unique search terms into the array of unique nodes.

10. A medium as in claim 7, further comprising updating the merged query result, wherein updating comprises:
determining that a delta postings list contains changes for the items in the merged query result; and
updating the merged query result in accordance with the delta postings list, including removing from the merged query result identifications of those items no longer containing the matching search term and adding to the merged query result identifications of those items newly containing the matching search term.

11. A medium as in claim 7, further comprising updating the merged query result, wherein updating comprises:
determining whether a live index contains postings lists for the term that matches the search term corresponding to the merged query;
processing the merged query against the live index; and
updating the merged query result in accordance with the live index merged query results.

11. A medium as in claim 7, wherein the inverted index is formed in pulses comprising a group of items not occurring in any other pulse in the inverted index, and further wherein generating the unified document set is limited to document sets present in postings lists found in a single pulse formed in the inverted index.

12. A data processing system comprising:
means for receiving multiple queries against an inverted index, the inverted index having stored thereon postings lists for terms, a postings list being a linked list of one or more nodes, each of the one or more nodes representing one or more items containing a term;
means for merging the multiple queries to a single merged query, the single merged query containing unique search terms extracted from the multiple queries;
means for generating a unified document set of document sets present in postings lists having items containing terms that match the unique search terms extracted from the multiple queries;
means for iterating the unified document set to generate a merged query result;
means for returning a query result responsive to each of the multiple queries, the query result being identified in a portion of the merged query result based on the respective unique search terms extracted from the multiple queries.

13. A query server for processing multiple queries against an inverted index, the query server comprising:
a query processor to service a first query against an inverted index, the first query received from a first application, the inverted index having stored thereon postings lists for terms, a postings list being a linked list of one or more nodes, each of the one or more nodes representing one or more items containing a term, wherein the query processor is to:
place the first query in a query queue if the query processor is busy;
upon becoming idle, combining the first query with a second query in the query queue into a single merged query, the second query having been received from a second application, the single merged query containing unique search terms extracted from the first and second queries;
generating a unified document set of document sets present in postings lists having items containing terms that match the unique search terms extracted from the first and second queries;
iterating the unified document set to generate a merged query result; and
returning a query result to each of the first and second applications responsive to each of the first and second queries, each query result being identified in a portion of the merged query result based on the respective unique search terms extracted from each of the first and second queries.

14. A query server as in claim 13, wherein the query processor is to further:
determine that a query received from an application contains multiple queries against the same inverted index; and
combining the multiple queries into a single merged query before servicing the query, including combining the multiple queries with other queries received from other applications.
